(19) United States
(12) Patent Application Publication
(10) Pub. No.: US 2024/0281215 A1
(43) Pub. Date: Aug. 22, 2024

(54) RECORDING MEDIUM, PROGRAMMING ASSISTING DEVICE, AND PROGRAMMING ASSISTING METHOD

(71) Applicant: Mitsubishi Electric Corporation, Tokyo (JP)

(72) Inventor: Shuto SATA, Tokyo (JP)

(73) Assignee: Mitsubishi Electric Corporation, Tokyo (JP)

(21) Appl. No.: 18/571,263

(22) PCT Filed: Dec. 21, 2021
(86) PCT No.: PCT/JP2021/047392

§ 371 Date: Dec. 18, 2023

(51) Int. Cl. G06F 8/10; G05B 19/05; G06F 8/20; G06T 11/20

(52) U.S. Cl. CPC G06F 8/10; G05B 19/05; G06F 8/24; G06T 11/206

(57) ABSTRACT

A programming assisting program causes a computer to function as a project information acquirer that acquires component information indicating a plurality of components included in a project including object-oriented components and relationships, and acquiring relationship information indicating relationships between the plurality of components, a generator that generates a class diagram indicating a structure of the project based on the acquired component information and the acquired relationship information, a display that displays the generated class diagram on a screen, and a display updater that receives a selection operation of selecting a component included in the class diagram displayed on the screen, and updates a display format of the class diagram such that a level of a relationship between the component selected in the selection operation and another component is distinguishable.

### TECHNICAL FIELD

The present disclosure relates to a programming assisting program, a programming assisting device, and a programming assisting method.

### BACKGROUND ART

A technique of visualizing a project structure in programming of a programmable logic controller (PLC) project is known. For example, Patent Literature 1 describes a technique for analyzing which function block (FB) is included in a project and what relationship is there between FBs included in the project, and displaying the analysis results in a tree diagram on a screen to identify the project structure.

### CITATION LIST

### Patent Literature

Patent Literature 1: Unexamined Japanese Patent Application Publication No. 2004-303217

### SUMMARY OF INVENTION

### Technical Problem

International Electrotechnical Commission (IEC) 61131-3 Part 3 that is the latest standard for the PLC introduces use of object-oriented components and relationships, such as an interface or inheritance, to enhance structured programming for creating projects performed by the PLC.

However, the technique in Patent Literature 1 simply displays the relationship between components included in a project in a tree diagram, and is not compliant with object-oriented components and relationships introduced in IEC 61131-3 Part 3. Thus, this technique may not identify the structure of a project including object-oriented components and relationships.

An objective of the present disclosure is to provide a programming assisting program, a programming assisting device, and a programming assisting method for easily identifying a structure of a project including object-oriented components and relationships.

### Solution to Problem

To achieve the above objective, a programming assisting program according to an aspect of the present disclosure causes a computer to function as
project information acquiring means for acquiring component information indicating a plurality of components included in a project including object-oriented components and relationships, and acquiring relationship information indicating relationships between the plurality of components,
generation means for generating a class diagram indicating a structure of the project based on the acquired component information and the acquired relationship information,
display means for displaying the generated class diagram on a screen, and
display update means for receiving a selection operation of selecting a component included in the class diagram displayed on the screen, and updating a display format of the class diagram such that a level of a relationship between the component selected in the selection operation and another component is distinguishable.

### Advantageous Effects of Invention

The technique according to the above aspect of the present disclosure can provide a programming assisting program, a programming assisting device, and a programming assisting method for easily identify a structure of a project including object-oriented components and relationships.

### BRIEF DESCRIPTION OF DRAWINGS

FIG. 1 is a diagram of a programming assisting device according to Embodiment 1, illustrating the functional structure;

FIG. 2 is a block diagram of the programming assisting device according to Embodiment 1, illustrating the hardware structure;

FIG. 3 is a table of example project information according to Embodiment 1;

FIG. 4 is a diagram of an example class diagram according to n Embodiment 1;

FIG. 5 is a diagram of the class diagram according to Embodiment 1 distinguishably displaying the levels of relationships;

FIG. 6 is a diagram of the class diagram according to Embodiment 1 distinguishably displaying the levels of relationships;

FIG. 7 is a diagram of the class diagram according to Embodiment 1 distinguishably displaying a selected relationship;

FIG. 8 is a diagram of the class diagram according to Embodiment 1 distinguishably displaying a selected relationship;

FIG. 9 is a diagram of the class diagram according to Embodiment 1 with some components hidden;

FIG. 10 is a diagram of the class diagram according to Embodiment 1 that has undergone an editing operation;

FIG. 11 is a table of example project information according to Embodiment 1;

FIG. 12 is a flowchart of a display process according to Embodiment 1;

FIG. 13 is a flowchart of a display updating process according to Embodiment 1;

FIG. 14 is a flowchart of an editing process according to Embodiment 1; and

FIG. 15 is a diagram of a programming assisting device according to Embodiment 2, illustrating the functional structure.

### DESCRIPTION OF EMBODIMENTS

### Embodiment 1

A programming assisting device 100 according to Embodiment 1 assists in programming of a project performed by a PLC. For example, the programming assisting device 100 implements an engineering tool. The programming assisting device 100 has a function of displaying, on a screen of the programming assisting device 100, a class diagram indicating a structure of a project including object-oriented components and relationships.

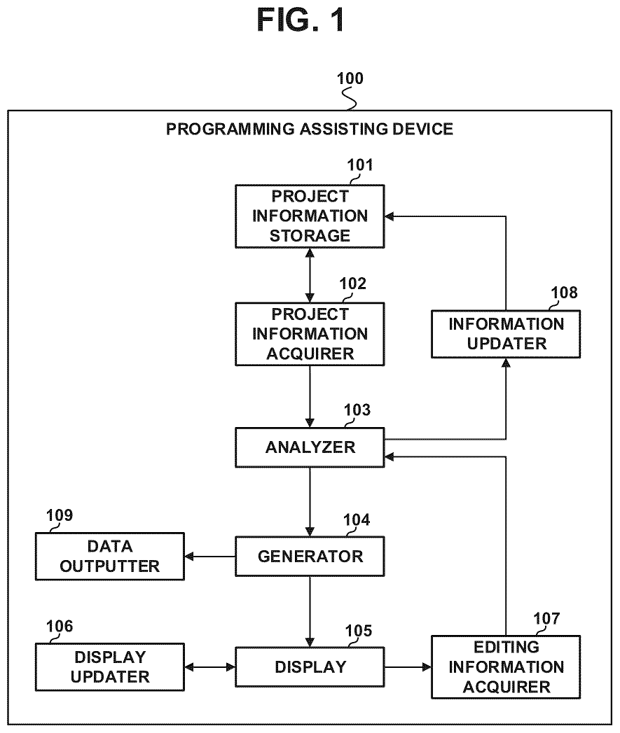

FIG. 1 is a diagram of the programming assisting device 100 illustrating the functional structure. The programming assisting device 100 includes, as functional components, a project information storage 101 that stores project information, a project information acquirer 102 that acquires project information, an analyzer 103 that acquires analysis information indicating a structure of a project based on the acquired project information, a generator 104 that generates a class diagram indicating the structure of the project based on the acquired analysis information, a display 105 that displays the class diagram on the screen, a display updater 106 that updates the class diagram based on a selection operation from a user, an editing information acquirer 107 that acquires editing information indicating content of the editing operation from the user, an information updater 108 that updates the project information based on the acquired editing information, and a data output unit 109 that outputs data about the class diagram.

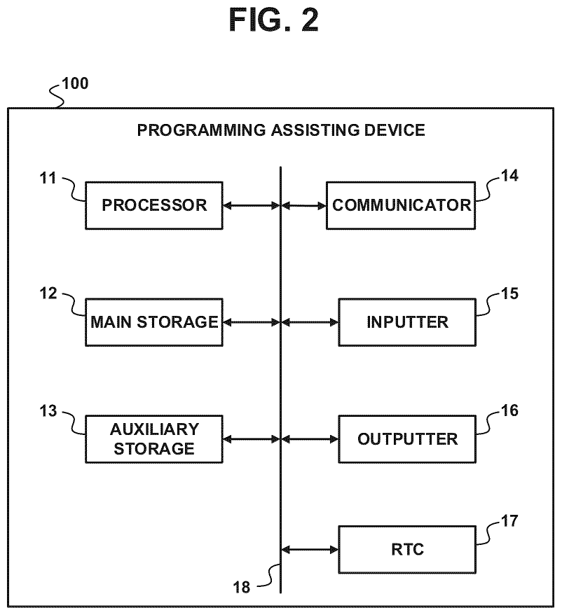

The programming assisting device 100 in FIG. 1 has the hardware structure illustrated in FIG. 2.

The programming assisting device 100 includes a processor 11 that performs various processes, a main storage 12 used as a work area for the processor 11, an auxiliary storage 13 that stores various types of data used for the processes of the processor 11, a communicator 14 for performing communications with external devices, an inputter 15 that acquires input information, an outputter 16 that provides various types of information, and a real time clock (RTC) 17 that measures time. The main storage 12, the auxiliary storage 13, the communicator 14, the inputter 15, the outputter 16, and the RTC 17 are connected to the processor 11 with a bus 18.

The processor 11 includes a central processing unit (CPU). The processor 11 implements various functions of the programming assisting device 100 by executing programs stored in the auxiliary storage 13.

The main storage 12 includes a random access memory (RAM). Programs are loaded into the main storage 12 from the auxiliary storage 13. The main storage 12 is used as a work area for the processor 11.

The auxiliary storage 13 includes a nonvolatile memory such as an electrically erasable programmable read-only memory (EEPROM). In addition to the programs, the auxiliary storage 13 stores various types of data used for processes performed by the processor 11. In response to instructions from the processor 11, the auxiliary storage 13 provides data to be used by the processor 11 to the processor 11, and stores data provided from the processor 11.

The communicator 14 includes a network interface circuit for communicating with external devices. The communicator 14 receives signals from the external devices and outputs data indicated by the signals to the processor 11. The communicator 14 transmits the signals indicating data output from the processor 11 to the external devices.

The inputter 15 includes an input device, such as input keys and a pointing device. The inputter 15 acquires information input by the user of the programming assisting device 100 and provides the acquired information to the processor 11.

The outputter 16 includes an output device, such as a liquid crystal display (LCD) and a speaker. The outputter 16 may form a touchscreen integrally with the pointing device included in the inputter 15. The outputter 16 provides various types of information to the user in response to instructions from the processor 11.

The RTC 17 is a clocking device including an oscillator circuit using a 25 crystal oscillator. For example, the RTC 17 includes a built-in battery and continues measuring time when the programming assisting device 100 is turned off.

The project information storage 101 in FIG. 1 stores project information. The project information includes component information indicating multiple components included in a project, and relationship information indicating relationships between the components. The structure of the project is described based on the component information and the relationship information. The project information storage 101 is implemented by the auxiliary storage 13. The project information storage 101 is an example of storing means.

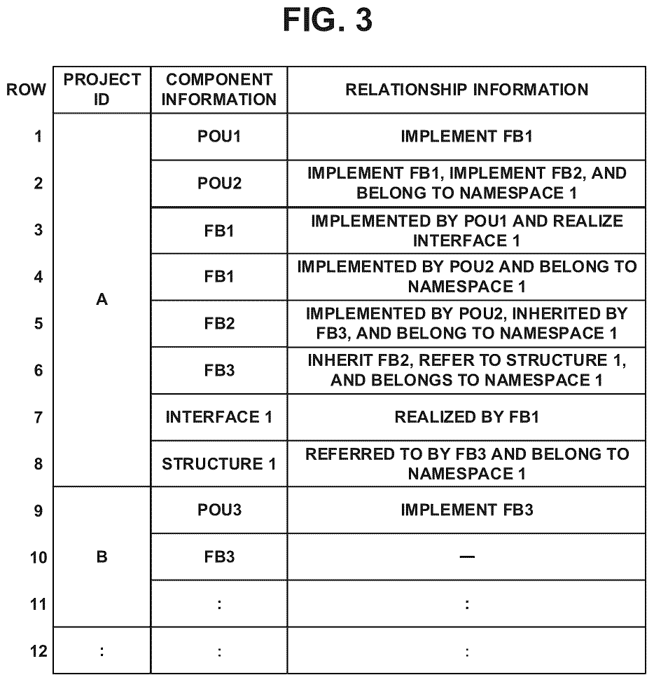

For example, the project information storage 101 stores a project information table illustrated in FIG. 3. The project information table in FIG. 3 records a project ID for identifying a project, component information indicating components included in the project, and relationship information indicating relationships between the components in association with one another. The project information table in FIG. 3 records projects including object-oriented components and relationships. Examples of the object-oriented components include a program organization unit (POU), an FB, an interface, and a structure. Examples of the object-oriented relationships include reference, implementation, inheritance, realization, and namespace. The component information and the relationship information in the project information table in FIG. 3 are updated at every creation and editing of projects.

For example, the record in the first row in the project information table in FIG. 3 indicates that a project A (project ID “A”) includes a component “POU1” and POU1 “implements FB1”.

The project information acquirer 102 in FIG. 1 acquires component information and relationship information. The project information acquirer 102 is implemented by the processor 11 and the inputter 15. The project information acquirer 102 is an example of project information acquiring means.

For example, when receiving an operation of displaying a class diagram for the project A from a user, the project information acquirer 102 refers to the project information table in FIG. 3 stored in the project information storage 101, and acquires the component information and relationship information associated with the project ID “A”. More specifically, the project information acquirer 102 acquires the component information and the relationship information in the first to eighth rows in the project information table in FIG. 3.

The analyzer 103 in FIG. 1 acquires first analysis information indicating the structure of the project based on the acquired component information and the acquired relationship information. The first analysis information is acquired based on the component information and relationship information acquired by the project information acquirer 102. The analyzer 103 is implemented by the processor 11. The analyzer 103 is an example of analyzing means.

For example, the analyzer 103 acquires, based on the component information and the relationship information in the first to eighth rows in the project information table in FIG. 3, first analysis information for the project A indicating that “POU1 implements FB1”, “POU2 implements FB1 and FB2 and belongs to namespace 1”, “FB1 is implemented by POU1 and realizes interface 1, FB1 is implemented by POU2 and belongs to namespace 1”, “FB2 is implemented by POU2, inherited by FB3, and belongs to namespace 1”, “FB3 inherits FB2, refers to (or is associated with) structure 1, and belongs to namespace 1”, “interface 1 is realized by FB1”, and “structure 1 is referred to by FB3 and belongs to namespace 1”.

The generator 104 in FIG. 1 generates a class diagram indicating the structure of the project based on the acquired first analysis information. The generator 104 is implemented by the processor 11. The generator 104 is an example of generation means.

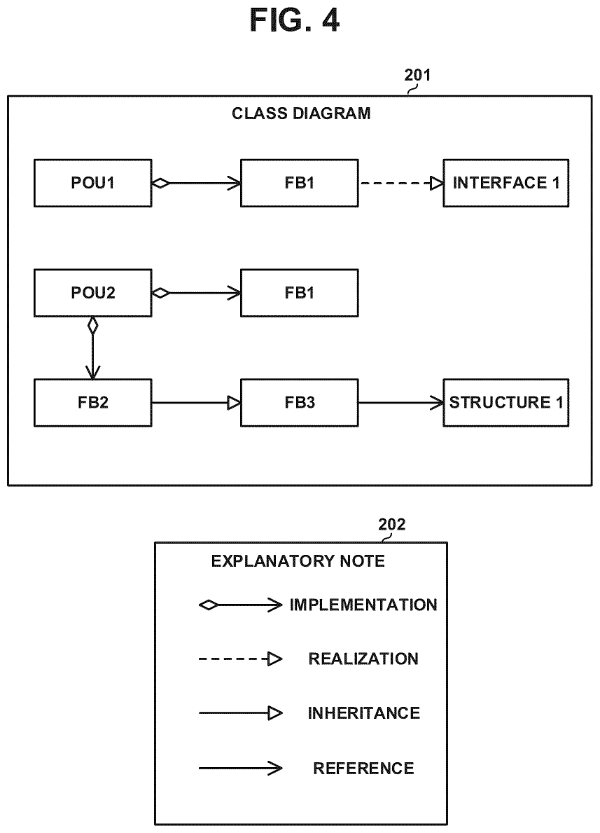

For example, the generator 104 generates a class diagram 201 in FIG. 4. The class diagram 201 illustrates components with blocks and relationships with lines and arrows. The lines and arrows are hereafter referred to as relationship lines. An explanatory note 202 in FIG. 4 lists association between the relationship and the relationship line. In the class diagram, components connected with a relationship line indicate that the components have a relationship indicated by the relationship line, and components unconnected with any relationship line have no relationship.

The display 105 in FIG. 1 displays the generated class diagram on the screen. The display 105 is implemented by the processor 11 and the outputter 16. The display 105 is an example of display means.

For example, the display 105 displays the class diagram 201 in FIG. 4 on a screen 300 in the programming assisting device 100.

The display updater 106 in FIG. 1 receives a selection operation of selecting a component included in the class diagram displayed on the screen, and updates a display format of the class diagram such that a level of the relationship between the component selected in the selection operation and another component is distinguishable. The display updater 106 is implemented by the processor 11 and the inputter 15. The display updater 106 is an example of display update means.

The level of the relationship is a degree by which components are related to each other. Components located at a closer distance to each other in the class diagram have a stronger relationship. The distance is indicated with the number of path components from the component selected by the user to another component. That is, more path components indicate a weaker relationship between the components, whereas fewer path components indicate a stronger relationship between the components.

The display updater 106 determines the number of path components from the component selected in the selection operation to another component in the class diagram, and updates the display format for more path components to indicate a weaker relationship.

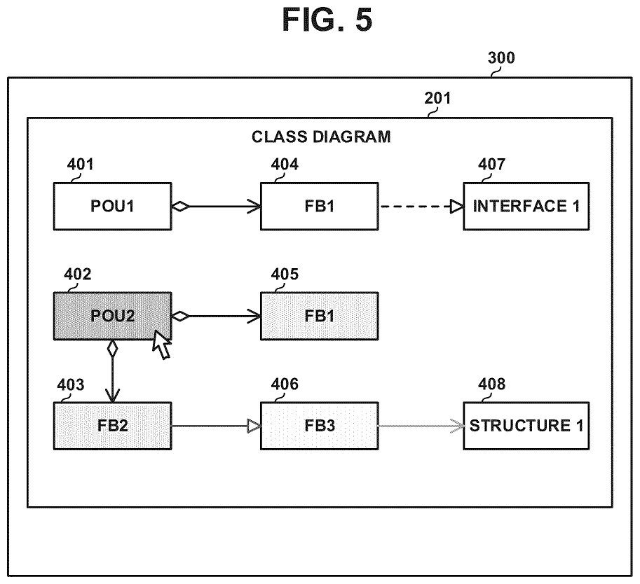

For example, as illustrated in FIG. 5, when the user selects a block 402 (POU2) with an operation such as mouseover or a left click on the class diagram 201 displayed on the screen 300, the display updater 106 receives the selection operation for the component of the block 402. The display updater 106 then determines the distance between the selected block 402 and another block connected to the block 402 with a relationship line. In the example of FIG. 5, the display updater 106 determines the distance to the block 402 as “0”, the distance to a block 403 (FB2) and a block 405 (FB1) as “1”, the distance to a block 406 (FB3) as “2”, and the distance to a block 408 (structure 1) as “3”. The display updater 106 changes the color shading of the block for which the distance from the selected block 402 is determined and the color shading of the relationship line connecting those blocks based on the distance from the selected block 402. More specifically, the display updater 106 further thickens the color of the block 402 for which the distance from the selected block is determined and the color of the relationship line connecting these blocks when the distance is shorter, in other words, when the path components are fewer.

The display updater 106 further receives a selection operation of selecting one of the relationships, and updates the display format of the class diagram such that a component having the relationship selected in the selection operation is distinguishable.

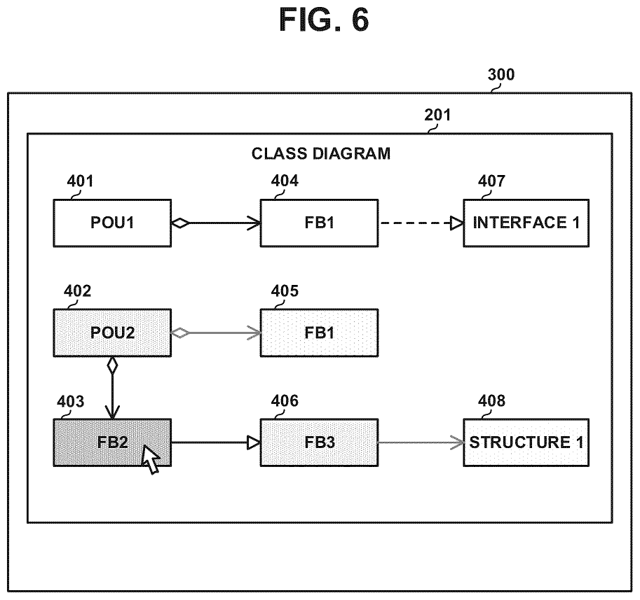

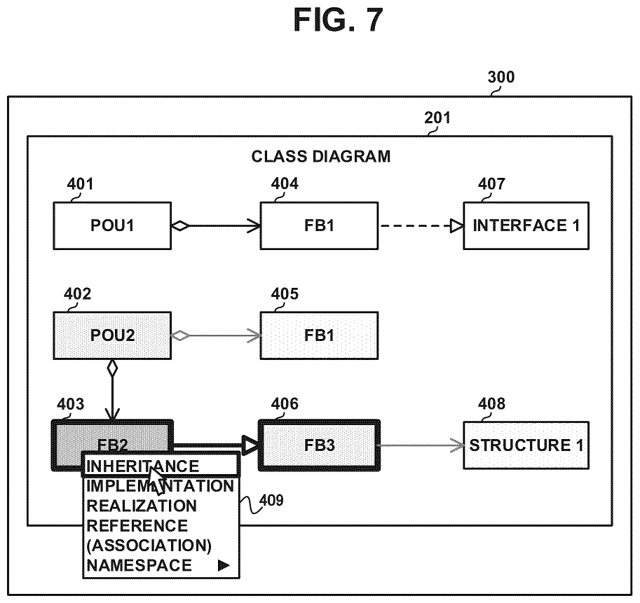

For example, as illustrated in FIG. 6, when the user places the mouse over the block 403 in the class diagram 201 displayed on the screen 300, the colors of the block 403 and other blocks connected to the block 403 with relationship lines and the color shading of the relationship lines are changed based on the distances. As illustrated in FIG. 7, when the user placing the mouse over the block 403 right-clicks, a panel 409 appears. The panel 409 lists items indicating relationships between components. When the user selects “inheritance” on the panel 409, the display updater 106 receives a selection operation of selecting the relationship of “inheritance” for the component of the block 403. As illustrated in FIG. 7, the display updater 106 highlights the frame line of the block 403, the frame line of the block 406 having the relationship of “inheritance” with the block 403, and the relationship line connecting the block 403 and the block 406 with bold lines.

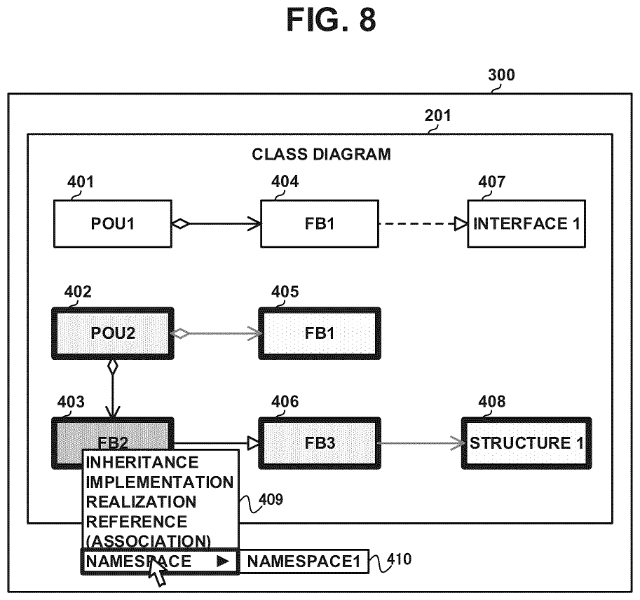

When “implementation”, “realization”, or “reference (association)” is selected on the panel 409, similarly to when inheritance is selected, the selected block, the block having the selected relationship with the selected block, and the relationship line connecting these blocks are highlighted. As illustrated in FIG. 8, when “namespace” is selected on the panel 409, a panel 410 containing “namespace 1” associated with the component of the selected block 403 appears on the screen. When the user selects “namespace 1”, the display updater 106 highlights the frame lines of the blocks 402, 403, 405, 406, and 408 of the components associated with “namespace 1” with bold lines.

The display updater 106 may update the display format to hide in the class diagram the components having no relationship with the component selected in the selection operation. The user can set, as appropriate, whether to hide components having no relationship with the selected component.

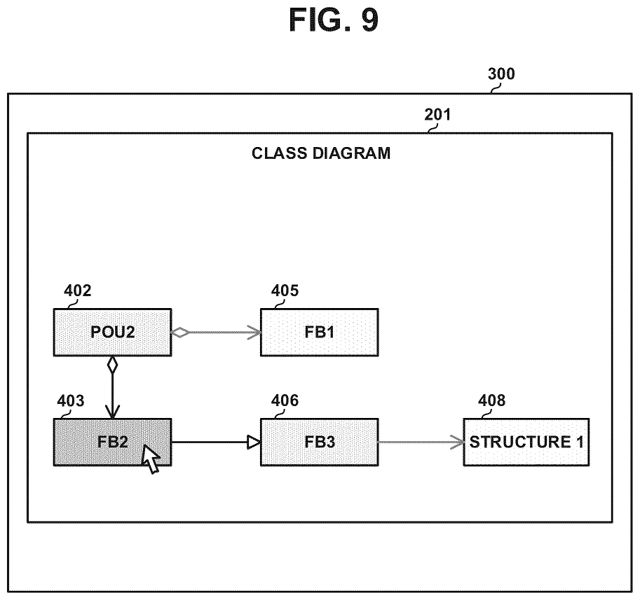

In one example, components having no relationship with the selected component are set to be hidden. As illustrated in FIG. 9, when the user selects the block 403 with an operation such as mouseover or a left click on the class diagram 201 displayed on the screen 300, the display updater 106 hides a block 401 (POU1), a block 404 (FB1), and a block 407 (interface 1) unconnected with the selected block 403 with relationship lines, and the relationship lines between these blocks.

The editing information acquirer 107 illustrated in FIG. 1 receives an editing operation on the class diagram displayed on the screen, and acquires editing information indicating content of the received editing operation. The editing information acquirer 107 is implemented by the processor 11 and the inputter 15. The editing information acquirer 107 is an example of editing information acquiring means.

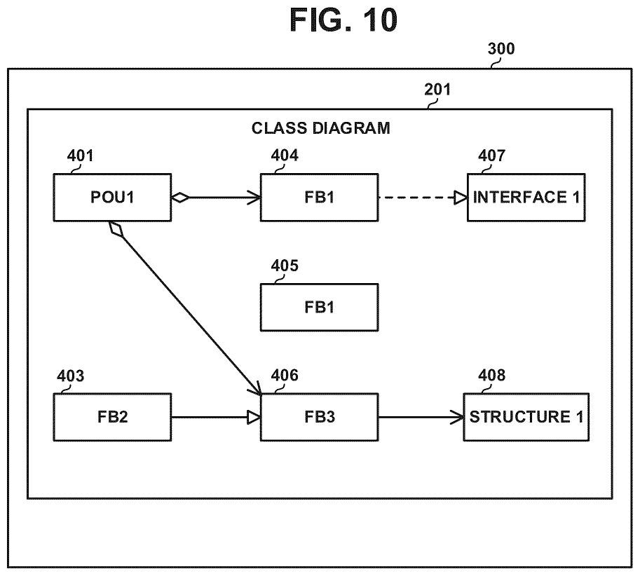

For example, as illustrated in FIG. 10, the user deletes the block 402 in the class diagram 201, and adds a relationship line of “inheritance” between the blocks 401 and 406. The editing information acquirer 107 receives an editing operation from the user, and acquires editing information indicating “deletion of the block 402” and “addition of the relationship line of the implementation from the block 401 to the block 406”.

The analyzer 103 acquires second analysis information indicating a structure of the project on which the acquired editing information is reflected. The second analysis information is the analysis information acquired based on the editing information acquired by the editing information acquirer 107.

For example, the analyzer 103 acquires second analysis results indicating that “POU2 is deleted, no longer has the implementation relationships with FB1 and FB2, and no longer belongs to namespace 1”, “POU1 implements FB3”, and “FB3 is implemented by POU1”.

The information updater 108 in FIG. 1 updates, based on the acquired second analysis information, the component information and the relationship information stored in the project information storage 101. The information updater 108 is implemented by the processor 11. The information updater 108 is an example of information updating means.

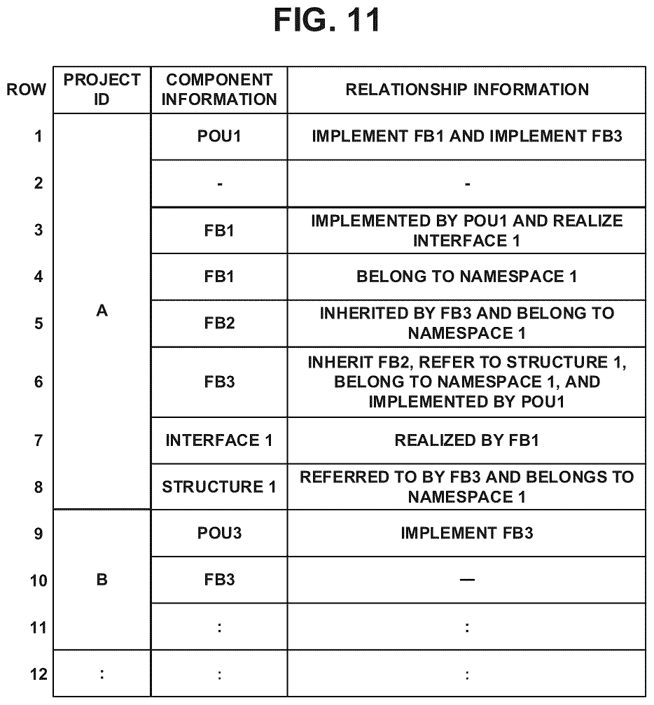

For example, as illustrated in FIG. 11, the information updater 108 adds “implement FB3” on the relationship information in the first row in the project information table, deletes the component information and the relationship information about “POU2” in the second row, deletes the relationship information indicating “implemented by POU2” in the fourth and fifth rows, and adds “implemented by POU1” to the relationship information in the sixth row.

The data output unit 109 in FIG. 1 receives a specification operation of specifying a file format in which the generated class diagram is to be output, and outputs the generated class diagram as data in the file format specified in the specification operation. The data output unit 109 is implemented by the processor 11. The data output unit 109 is an example of data output means.

The specified file format allows a device with no functions of the programming assisting device 100 illustrated in FIG. 1 to display the class diagram, and is, for example, an image file format. For example, when the data output unit 109 receives, from the user, a specification operation of specifying the gif file format and an output operation of outputting the class diagram 201 in FIG. 4 in the gif file format, the data output unit 109 outputs the class diagram 201 illustrated in FIG. 4 in the gif file format.

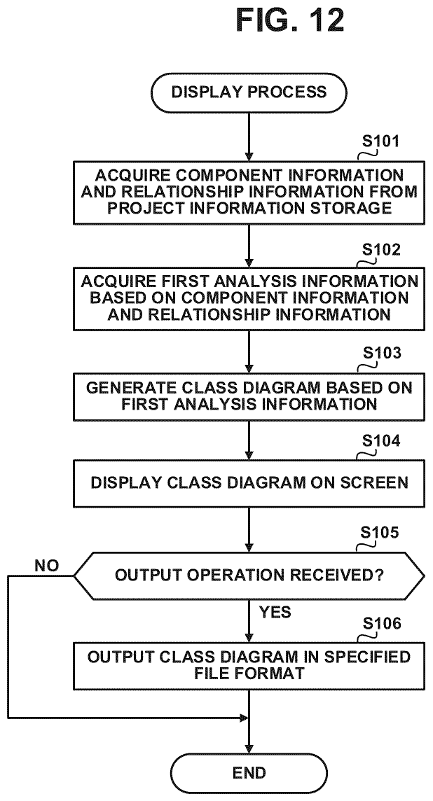

A display process performed by the programming assisting device 100 according to the present embodiment is described now with reference to the flowchart in FIG. 12. The display process in FIG. 12 is performed when an operation of displaying the class diagram of a project is received from the user.

When the project information acquirer 102 receives an operation of displaying the class diagram of a project from the user, the project information acquirer 102 acquires the component information and the relationship information from the project information storage 101 (step S101).

For example, when receiving an operation of displaying the class diagram of the project A from the user, the project information acquirer 102 refers to the project information table stored in the project information storage 101 and acquires the component information and the relationship information in the first to eighth rows associated with the project ID “A”.

The analyzer 103 acquires first analysis information indicating the structure of the project based on the acquired component information and the acquired relationship information (step S102).

For example, the analyzer 103 acquires, based on the component information and the relationship information in the first to eighth rows in the project information table in FIG. 3, first analysis information for the project A indicating that, for example, “POU1 implements FB1”, and “POU2 implements FB1 and FB2 and belongs to namespace 1”.

The generator 104 generates the class diagram indicating the structure of the project based on the acquired first analysis information (step S103).

For example, the generator 104 generates the class diagram 201 illustrated in FIG. 4.

The display 105 displays the generated class diagram on the screen (step S104).

For example, as illustrated in FIG. 5, the display 105 displays the class diagram 201 on the screen 300 in the programming assisting device 100.

The data output unit 109 determines whether an output operation of outputting the generated class diagram in a file format is received (step S105). When determining that the output operation of outputting the generated class diagram in a file format is received (YES in step S105), the data output unit 109 outputs the generated class diagram as data in the file format specified by the user (step S106). When determining that the output operation of outputting the generated class diagram in a file format is not received (NO in step S105), the data output unit 109 ends the display process in FIG. 12.

For example, when the data output unit 109 receives the specification operation of specifying the gif file format and receives the output operation of outputting the class diagram 201 in the gif file format from the user, the data output unit 109 outputs the class diagram 201 illustrated in FIG. 4 in the gif file format. When the data output unit 109 does not receive the output operation of outputting the class diagram 201 from the user, the data output unit 109 ends the display process in FIG. 12.

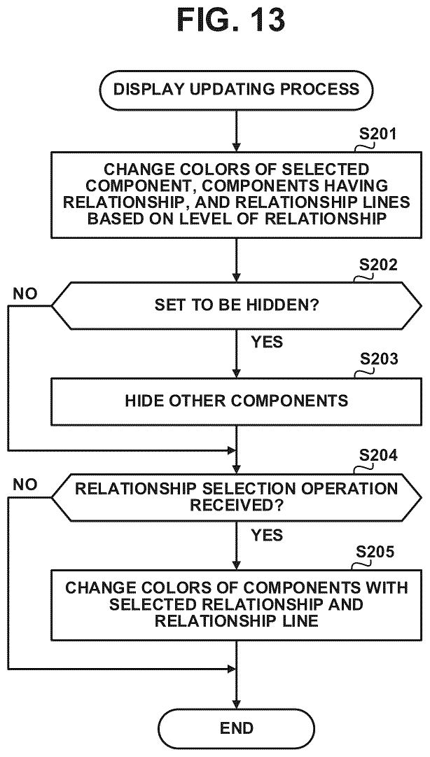

The display updating process performed by the programming assisting device 100 according to the present embodiment is now described with reference to the flowchart in FIG. 13. The display updating process in FIG. 13 is performed when a selection operation of selecting a component included in the class diagram displayed on the screen is received from the user.

When the display updater 106 receives the selection operation of selecting a component included in the class diagram displayed on the screen from the user, the display updater 106 changes the colors of the selected component, the components having a relationship with the selected component, and the relationship lines connecting these components based on the level of the relationship (step S201).

For example, as illustrated in FIG. 6, when the display updater 106 receives the selection operation of selecting the component of the block 403, the display updater 106 determines the distances between the block 403 and other blocks connected to the block 403 with relationship lines, and changes, based on the determined distances, the color shading of the block 403, the other blocks connected to the block 403 with the relationship lines, and the relationship lines connecting these blocks.

Subsequently, the display updater 106 determines whether the components having no relationship with the selected component are set to be hidden in the class diagram (step S202). When determining that the components having no relationship with the selected component are set to be hidden (YES in step S202), the display updater 106 hides the components having no relationship with the component selected by the user in the class diagram (step S203). When the display updater 106 determines that the components having no relationship with the selected component are not set to be hidden (NO in step S202), the processing advances to step S204.

For example, when determining that the components having no relationship with the selected component are set to be hidden in the class diagram, as illustrated in FIG. 9, the display updater 106 hides the blocks 401, 404, and 407 unconnected with the selected block 403 with relationship lines, and the relationship lines between these blocks in the class diagram 201 displayed on the screen 300. When the display updater 106 determines that the components having no relationship with the selected component are not set to be hidden in the class diagram, the processing advances to step S205 without changing the display in FIG. 6.

The display updater 106 determines whether the selection operation of selecting the relationship is further received from the user (step S204). When determining that the selection operation of selecting the relationship is further received from the user (YES in step S204), the display updater 106 changes the colors of the components having the selected relationship and the relationship line indicating the selected relationship (step S205). When determining that the selection operation of selecting the relationship is not received from the user (NO in step S204), the display updater 106 ends the display updating process in FIG. 13.

For example, as illustrated in FIG. 7, when the display updater 106 receives a selection of the relationship of “inheritance” for the component of the block 403, the display updater 106 thickens the frame line of the block 403, the frame line of the block 406 having the relationship of “inheritance” with the block 403, and the relationship line connecting the blocks 403 and 406 further than the other frame lines and relationship lines, and then ends the display updating process.

The editing process performed by the programming assisting device 100 according to the present embodiment is now described with reference to the flowchart in

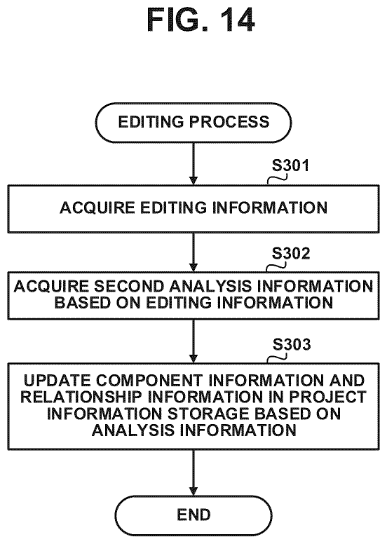

FIG. 14. The editing process in FIG. 14 is performed when an editing operation on the class diagram displayed on the screen is received from the user.

When receiving an editing operation on the class diagram displayed on the screen from the user, the editing information acquirer 107 acquires editing information indicating content of the editing operation (step S301).

For example, when receiving, from the user, an editing operation of deleting the block 402 and adding an “inheritance” relationship line between the blocks 401 and 406, the editing information acquirer 107 acquires editing information indicating “deletion of the block 402” and “addition of the relationship line of the implementation from the block 401 to the block 406”.

The analyzer 103 acquires second analysis information indicating a structure of the structure on which the acquired editing information is reflected (step S302).

For example, the analyzer 103 acquires second analysis results indicating that “POU2 is deleted, no longer has the implementation relationships with FB1 and FB2, and no longer belongs to namespace 1”, “POU1 implements FB3”, and “FB3 is implemented by POU1”.

The information updater 108 updates, based on the acquired second analysis information, the component information and the relationship information stored in the project information storage 101 (step S303). The information updater 108 then ends the editing process in FIG. 14.

For example, as illustrated in FIG. 11, the information updater 108 updates the component information and the relationship information in first, second, and fourth to sixth rows in the project information table, and ends the editing process.

A project with a larger scale includes more components. The project thus has more hierarchy layers and uses more time to identify the information about a specific component. However, the present embodiment can display a project including object-oriented components and relationships as a class diagram indicating a structure of a project. When the user selects a component in the class diagram, the level of the relationship between the selected component and another component can be distinguishably displayed. Thus, the structure can easily identify the structure of the project including object-oriented components and relationships, reducing the time taken to identify the structure of the project.

According to the present embodiment, an editing operation performed on the class diagram can achieve updating of the component information and the relationship information for describing a project, thus promoting structured programming.

According to the present embodiment, the generated class diagram can be output in a file format specified by the user. This provides an ability to check the class diagram in a device with no functions of a programming assisting device and a general application, thus enhancing user convenience.

### Embodiment 2

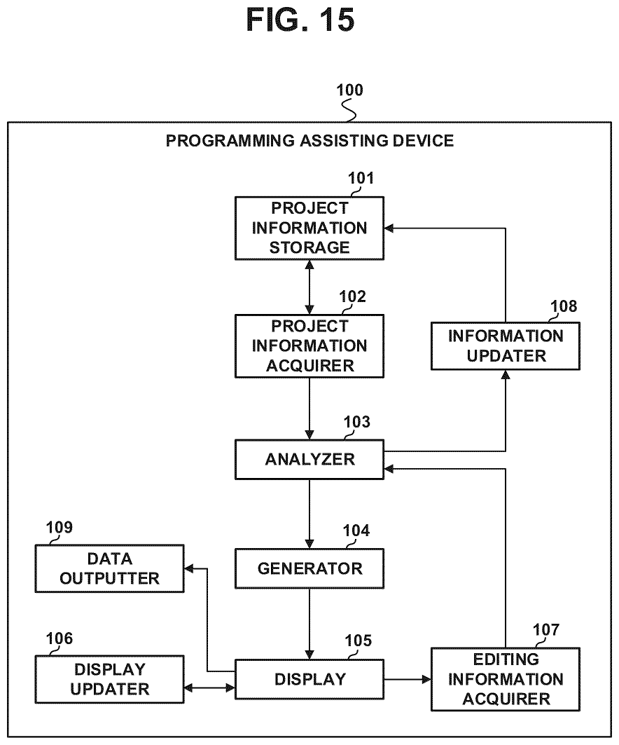

As illustrated in FIG. 15, a programming assisting device according to Embodiment 2 includes, as functional components, a project information storage 101 that stores project information, a project information acquirer 102 that acquires project information, an analyzer 103 that acquires analysis information indicating a structure of a project based on the acquired project information, a generator 104 that generates a class diagram indicating the structure of a project based on the acquired analysis information, a display 105 that displays the class diagram on the screen, a display updater 106 that updates the class diagram based on the selection operation from a user, an editing information acquirer 107 that acquires editing information indicating content of the editing operation from the user, an information updater 108 that updates the project information based on the acquired editing information, and a data output unit 109 that outputs data about the class diagram.

The project information storage 101, the project information acquirer 102, the analyzer 103, the generator 104, the display 105, the display updater 106, the editing information acquirer 107, and the information updater 108 in Embodiment 2 are the same as the components in Embodiment 1. The data output unit 109 having a different function is described below.

The data output unit 109 in FIG. 15 receives a specification operation of specifying a file format in which the class diagram with the updated display format is to be output, and outputs the class diagram with the updated display format as data in the file format specified in the specification operation. The data output unit 109 is implemented by the processor 11. The data output unit 109 is an example of data output means.

For example, the data output unit 109 receives the specification operation of specifying a gif file format from the user, receives an instruction of outputting the class diagram 201 in FIG. 6 in the gif file format, and outputs the class diagram 201 in FIG. 6 in the gif file format.

According to the present embodiment, the class diagram with the updated display format can be output in the file format specified by the user. This provides an ability to check the class diagram, in which the component selected by the user and the relationship are highlighted, in a device with no functions of a programming assisting device and a general application, thus enhancing user convenience.

### Modifications

Although the embodiments of the present disclosure are described above, the embodiments of the present disclosure may be modified or applied in various manners.

For example, the programming assisting device 100 may be configured of a combination of Embodiments 1 and 2. More specifically, the data output unit 109 may output the generated class diagram and the class diagram with the updated display format as data in a file format specified in the specification operation.

In the above embodiment, when a user selects a relationship, the display updater 106 updates the display format such that the level of the relationship and the selected relationship is distinguishable. For example, as illustrated in FIG. 6, after changing the color shading of the blocks and the relationship lines based on the level of the relationship, the display updater 106 changes the thickness of the frame lines of the blocks relating to the selected relationship and the relationship lines as illustrated in FIG. 7. However, the display format may be updated in another manner. For example, the display updater 106 may update the display format such that the selected relationship alone is distinguishable. For example, as illustrated in FIG. 7, when “inheritance” is selected on the panel 409, the display updater 106 may simply change the colors of the block 403, the block 406 having the relationship of “inheritance” with the block 403, and the relationship line connecting the blocks 403 and 406 without changing the colors of other blocks and relationship lines from the colors in the class diagram 201 in FIG. 4.

An operation program describing the operation of the programming assisting device 100 according to the above embodiments may be used for an existing personal computer or information terminal device to cause the personal computer or the information terminal device to function as the programming assisting device 100 according to the embodiments.

The program described above may be distributed in any manner. For example, the program may be stored in a non-transitory computer-readable recording medium such as a compact disk read-only memory (CD-ROM), a digital versatile disk (DVD), or a memory card to be distributed, or distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The technique according to one or more embodiments of the present disclosure can provide a programming assisting program, a programming assisting device, and a programming assisting method that can easily identify a structure of a project including object-oriented components and relationships.

### REFERENCE SIGNS LIST

11 Processor
12 Main storage
13 Auxiliary storage
14 Communicator
15 Inputter
16 Outputter
17 RTC
18 Bus
100 Programming assisting device
101 Project information storage
102 Project information acquirer
103 Analyzer
104 Generator
105 Display
106 Display updater
107 Editing information acquirer
108 Information updater
109 Data output unit
201 Class diagram
202 Explanatory note
300 Screen
401 to 408 Block
409, 410 Panel

1. A non-transitory computer-readable recording medium storing a programming assisting program, the programming assisting program causing a computer to execute processing comprising:
acquiring component information indicating a plurality of components included in a project including object-oriented components and relationships, and acquiring relationship information indicating relationships between the plurality of components;
generating a class diagram indicating a structure of the project based on the acquired component information and the acquired relationship information;
displaying the generated class diagram on a screen; and
receiving a selection operation of selecting a component included in the class diagram displayed on the screen, and updating a display format of the class diagram such that a level of a relationship between the component selected in the selection operation and another component is distinguishable, wherein
the updating includes updating the display format of the class diagram such that the level of the relationship is distinguishable in accordance with a distance from the component selected in the selection operation to the another component in the class diagram.

2. The non-transitory computer-readable recording medium according to claim 1, wherein
the receiving and updating includes receiving a selection operation of selecting one of the relationships, and updating the display format of the class diagram such that a component having the relationship selected in the selection operation is distinguishable.

3. The non-transitory computer-readable recording medium according to claim 1, wherein
the updating includes updating the display format to hide in the class diagram a component having no relationship with the component selected in the selection operation.

4. The non-transitory computer-readable recording medium according to claim 1, the programming assisting program further causing the computer to execute the processing comprising:
acquiring first analysis information indicating the structure of the project based on the acquired component information and the acquired relationship information, wherein
the generating includes generating the class diagram based on the acquired first analysis information.

5. The non-transitory computer-readable recording medium according to according to claim 4, wherein
the component information indicating the plurality of components included in the project and the relationship information indicating the relationships between the plurality of components are stored in a storage,
the acquiring of the component information and the relationship information includes acquiring the component information and the relationship information from the storage, and
the programming assisting program further causes the computer to execute the processing comprising
receiving an editing operation on the class diagram displayed on the screen, and acquiring editing information indicating content of the received editing operation,
acquiring second analysis information indicating a structure of the project on which the acquired editing information is reflected, and
updating, based on the acquired second analysis information, the component information and the relationship information stored in the storage.

6. The non-transitory computer-readable recording medium according to claim 1, the programming assisting program further causing the computer to execute the processing comprising:
receiving a specification operation of specifying a file format in which the generated class diagram or a class diagram with the updated display format is to be output, and outputting the generated class diagram or the class diagram with the updated display format as data in the file format specified in the specification operation.

7. (canceled)

8. The non-transitory computer-readable recording medium according to claim 1, wherein
the plurality of components indicated by the component information includes a program organization unit, a function block, an interface, and a structure, and
the relationships indicated by the relationship information include reference, implementation, inheritance, realization, and namespace.

9. A programming assisting device, comprising:
processing circuitry; and
a storage,
the processing circuitry being configured to
acquire component information indicating a plurality of components included in a project including object-oriented components and relationships, and acquire relationship information indicating relationships between the plurality of components,
generate a class diagram indicating a structure of the project based on the acquired component information and the acquired relationship information,
display the generated class diagram on a screen, and
receive a selection operation of selecting a component included in the class diagram displayed on the screen, and update a display format of the class diagram such that a level of a relationship between the component selected in the selection operation and another component is distinguishable, wherein
the processing circuitry updates the display format of the class diagram such that the level of the relationship is distinguishable in accordance with a distance from the component selected in the selection operation to the another component in the class diagram.

10. A programming assisting method, comprising:
acquiring component information indicating a plurality of components included in a project including object-oriented components and relationships, and acquiring relationship information indicating relationships between the plurality of components;
generating a class diagram indicating a structure of the project based on the acquired component information and the acquired relationship information;
displaying the generated class diagram on a screen; and
receiving a selection operation of selecting a component included in the class diagram displayed on the screen, and updating a display format of the class diagram such that a level of a relationship between the component selected in the selection operation and another component is distinguishable, wherein
the updating includes updating the display format of the class diagram such that the level of the relationship is distinguishable in accordance with a distance from the component selected in the selection operation to the another component in the class diagram.

11. The non-transitory computer-readable recording medium according to claim 2, wherein
the updating includes updating the display format to hide in the class diagram a component having no relationship with the component selected in the selection operation.

12. The non-transitory computer-readable recording medium according to claim 2, the programming assisting program further causing the computer to execute the processing comprising:
acquiring first analysis information indicating the structure of the project based on the acquired component information and the acquired relationship information, wherein
the generating includes generating the class diagram based on the acquired first analysis information.

13. The non-transitory computer-readable recording medium according to claim 3, the programming assisting program further causing the computer to execute the processing comprising:
acquiring first analysis information indicating the structure of the project based on the acquired component information and the acquired relationship information, wherein
the generating includes generating the class diagram based on the acquired first analysis information.

14. The non-transitory computer-readable recording medium according to claim 2, the programming assisting program further causing the computer to execute the processing comprising:
receiving a specification operation of specifying a file format in which the generated class diagram or a class diagram with the updated display format is to be output, and outputting the generated class diagram or the class diagram with the updated display format as data in the file format specified in the specification operation.

15. The non-transitory computer-readable recording medium according to claim 3, the programming assisting program further causing the computer to execute the processing comprising:
receiving a specification operation of specifying a file format in which the generated class diagram or a class diagram with the updated display format is to be output, and outputting the generated class diagram or the class diagram with the updated display format as data in the file format specified in the specification operation.

16. The non-transitory computer-readable recording medium according to claim 4, the programming assisting program further causing the computer to execute the processing comprising:
receiving a specification operation of specifying a file format in which the generated class diagram or a class diagram with the updated display format is to be output, and outputting the generated class diagram or the class diagram with the updated display format as data in the file format specified in the specification operation.

17. The non-transitory computer-readable recording medium according to claim 5, the programming assisting program further causing the computer to execute the processing comprising:
receiving a specification operation of specifying a file format in which the generated class diagram or a class diagram with the updated display format is to be output, and outputting the generated class diagram or the class diagram with the updated display format as data in the file format specified in the specification operation.

18. The non-transitory computer-readable recording medium according to claim 2, wherein
the plurality of components indicated by the component information includes a program organization unit, a function block, an interface, and a structure, and
the relationships indicated by the relationship information include reference, implementation, inheritance, realization, and namespace.

19. The non-transitory computer-readable recording medium according to claim 3, wherein
the plurality of components indicated by the component information includes a program organization unit, a function block, an interface, and a structure, and
the relationships indicated by the relationship information include reference, implementation, inheritance, realization, and namespace.

20. The non-transitory computer-readable recording medium according to claim 4, wherein
the plurality of components indicated by the component information includes a program organization unit, a function block, an interface, and a structure, and
the relationships indicated by the relationship information include reference, implementation, inheritance, realization, and namespace.

21. The non-transitory computer-readable recording medium according to claim 5, wherein
the plurality of components indicated by the component information includes a program organization unit, a function block, an interface, and a structure, and
the relationships indicated by the relationship information include reference, implementation, inheritance, realization, and namespace.
